(19) United States
(12) Patent Application Publication
(10) Pub. No.: US 2010/0210247 A1
(43) Pub. Date: Aug. 19, 2010

(54) MULTI-STANDBY TERMINAL AND METHOD OF PROVIDING CALL WAITING SOUND THEREOF

(75) Inventors: Won Hui KWON, Gyeonggi-do (KR); In Kook YOON, Gyeonggi-do (KR); Dong In HA, Seoul (KR); Jong Cheon JEONG, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/706,092

(22) Filed: Feb. 16, 2010

(30) Foreign Application Priority Data
Feb. 17, 2009 (KR) 10-2009-0012755

(51) Int. Cl. H04L 12/58

(52) U.S. Cl. 455/412.1

(57) ABSTRACT

A multi-standby terminal and a method of providing a call waiting sound thereof eliminate the need for subscribing to a call-waiting service. The multi-standby terminal preferably includes: a first RF unit for forming a communication channel with a first terminal; a second RF unit for receiving a communication request from a second terminal; an audio processor for outputting a call connecting sound notifying that a communication request from the second terminal is received; an input unit including a function key for generating an another party change signal for changing to another party; a first controller for controlling, when the another party change signal is input, to set the first terminal to a call waiting state and to transmit preset call waiting sound to the first terminal through the first RF unit; and a second controller for controlling to perform communication with the second terminal through the second RF unit.

### CLAIM OF PRIORITY

This application claims the benefit of priority from Korean Patent Application No. 10-2009-0012755 filed in the Korean Intellectual Property Office on Feb. 17, 2009, the entire contents of which are incorporated herein by reference in its entirety.

### BACKGROUND OF THE INVENTION

1. Field of the Invention

The present invention relates to a method of providing call waiting sound. More particularly, the present invention relates to a multi-standby terminal and call waiting services.

2. Description of the Related Art

With the recent developments of mobile communication technology, mobile communication providers provide a call waiting service. The call waiting service operates such that when a communication from a third terminal is requested with a first terminal, while the first terminal is currently performing communication with a second terminal, a service is provided that enables converting communication with the second terminal to a temporary call waiting state, and to perform communication with the third terminal. In this case, the mobile communication provider can provide call awaiting sound (for example, a voice message and/or music) to the terminal in the call waiting state. However, the call waiting service uses only contents (music and a voice message) provided by the mobile communication server as call the waiting sound. Further, in order to use call waiting service, it is necessary to subscribe to an additional service of a mobile communication provider.

Therefore, there is a long felt need in the art for a method of providing contents stored in a user's terminal as call waiting sound without subscribing to an additional service, i.e. without using the mobile communication server.

### SUMMARY OF THE INVENTION

The present invention provides a multi-standby terminal and a method of providing a call waiting sound thereof that can provide the call waiting sound to a terminal in a call waiting state without the requiring primary user who has received the calls to subscribe to a call waiting service using a mobile communication server.

In accordance with an exemplary aspect of the present invention, a multi-standby terminal preferably includes: a first RF unit for forming a communication channel with a first terminal; a second RF unit for receiving a communication request from a second terminal; an audio processor for outputting a call connecting sound notifying that a communication request is received from the second terminal; an input unit including a function key for generating an another party change signal for requesting changing to another party; a first controller for controlling, when an another party change signal is input, setting of the first terminal to a call waiting state and transmitting a preset call waiting sound to the first terminal through the first RF unit; and a second controller for controlling performing communication with the second terminal through the second RF unit.

In accordance with another exemplary aspect of the present invention, a method of providing call waiting sound for a multi-standby terminal that can perform call waiting with a plurality of wireless communication networks preferably includes: performing communication with a first terminal through a first RF unit; receiving a communication connection request from a second terminal through a second RF unit; determining whether a function key signal for changing to another party is input; setting, if a function key signal for changing to another party is input, the first terminal to a call waiting state and performing communication with the second terminal; and transmitting a preset call waiting sound to the first terminal that is associated with the call waiting state through the first RF unit.

### BRIEF DESCRIPTION OF THE DRAWINGS

The objects, features and advantages of the present invention will become more apparent from the following detailed description in conjunction with the accompanying drawings, in which:

FIG. 1 is a diagram illustrating a multi-standby terminal and a method of providing call waiting sound thereof according to an exemplary embodiment of the present invention;

FIG. 2 is a block diagram illustrating a configuration of a multi-standby terminal according to another exemplary embodiment of the present invention;

FIG. 3 is a flowchart illustrating a general overview of a method of providing call waiting sound according to another exemplary embodiment of the present invention; and

FIG. 4 is a flowchart illustrating a method of providing call waiting sound of a multi-standby terminal according to yet another exemplary embodiment of the present invention.

### DETAILED DESCRIPTION

Hereinafter, exemplary embodiments of the present invention are described in detail with reference to the accompanying drawings. The same reference numbers are used throughout the drawings to refer to the same or like parts.

Detailed descriptions of well-known functions and structures incorporated herein may be omitted to avoid obscuring appreciation of the subject matter of the present invention by a person of ordinary skill in the art.

While the present invention may be embodied in many different forms, specific embodiments of the present invention are shown in drawings and are described herein in detail, with the understanding that the present disclosure is to be considered as an exemplification of the principles of the invention and is not intended to limit the claimed invention to the specific examples illustrated herein.

In the following description, a “call waiting state” comprises a state in which a multi-standby terminal temporarily discontinues communication with a specific terminal without disconnecting the call in order to perform communication with another terminal, and connects only a communication channel with the specific terminal.

“Call waiting sound” refers to data for transmitting to a terminal in a call waiting state in order to notify that a user is performing communication with another terminal. Such call waiting sound may be formed with contents such as a music file, moving picture file, and voice message stored in the multi-standby terminal.

Hereinafter, for convenience of description, audio dedicated communication and audiovisual communication are referred to as “communication”.

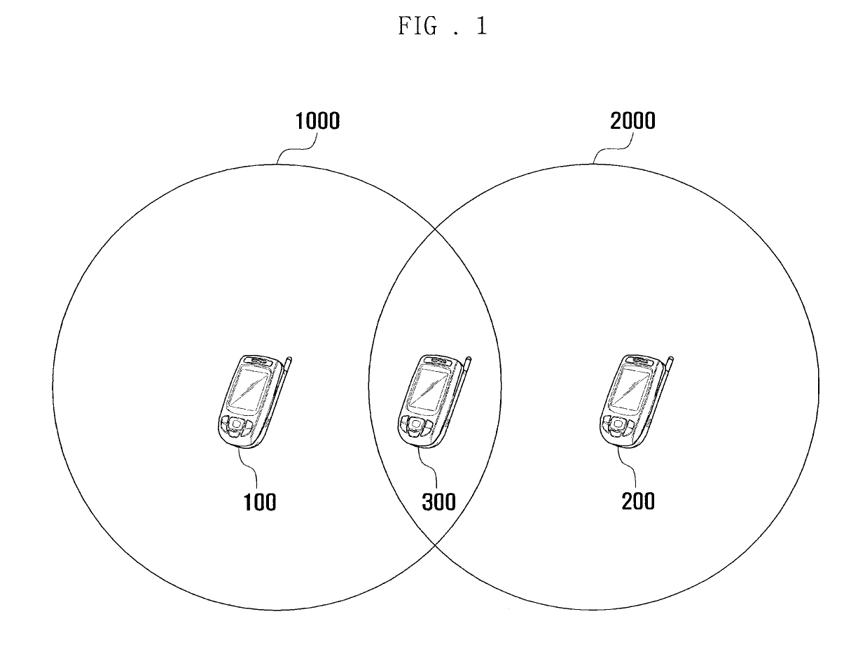

FIG. 1 is a diagram illustrating a multi-standby terminal and a method of providing call waiting sound thereof according to an exemplary embodiment of the present invention.

The multi-standby terminal comprises a mobile terminal that can perform a call waiting operation with a plurality of wireless communication networks using the same wireless communication protocol or different communication protocols. For example, the multi-standby terminal can use various wireless communication protocols such as Global System for Mobile Communication (GSM), code division multiple access (CDMA), wideband code division multiple access (WCDMA), general packet radio service (GPRS), and enhanced data GSM environment (EDGE), just to name a few possibilities. Hereinafter, for convenience of description, the multi-standby terminal performs call waiting with two wireless communication networks 1000, 2000.

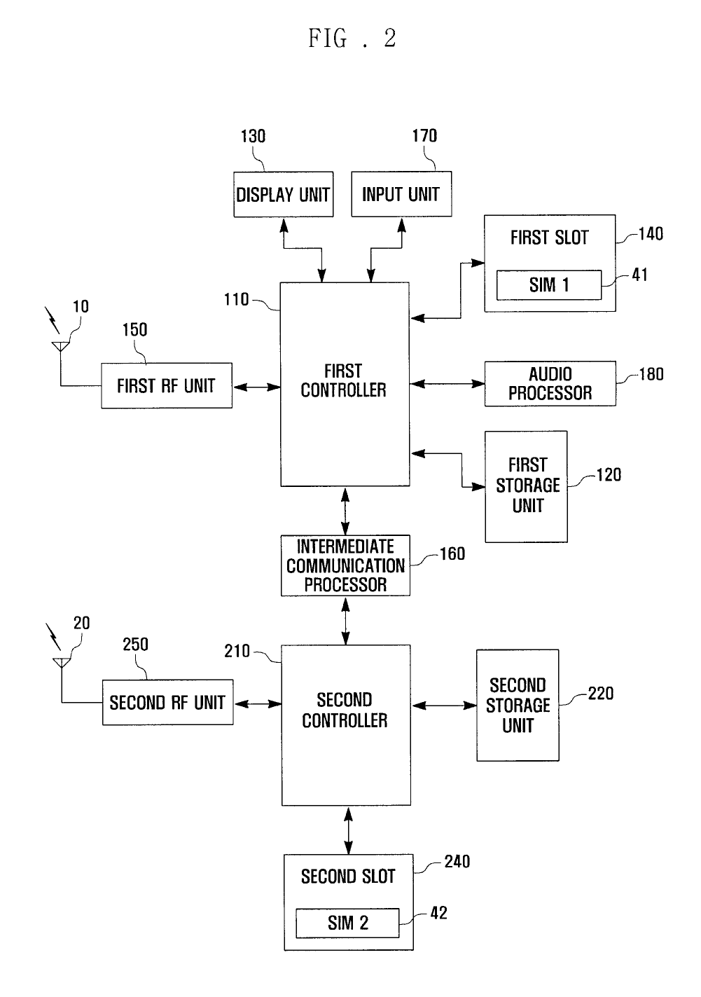

Referring now to FIG. 1, a multi-standby terminal 300 according to the present exemplary embodiment forms a communication channel with each of a first terminal 100 and a second terminal 200. That is, the multi-standby terminal 300 forms a communication channel with the first terminal 100 through a first RF unit 150 (shown in FIG. 2) and forms a communication channel with the second terminal 200 through a second RF unit 250 (shown in FIG. 2).

For example, the multi-standby terminal 300 receives a communication request from the second terminal 200 through the second RF unit 250 while performing communication with the first terminal 100 through the first RF unit 150. In this case, when the user selects a communication connection with the second terminal 200, the multi-standby terminal 300 sets the first terminal 100 to a call waiting state and performs a communication connection with the second terminal 200. Thereafter, the multi-standby terminal 300 transmits a preset call waiting sound (for example, a music file and a moving picture file) to the first terminal 100. Alternatively, when a communication connection request is received from the first terminal 100 while performing communication with the second terminal 200, the multi-standby terminal 300 can set the second terminal 200 to a call waiting state and transmit the call waiting sound to the second terminal 200. A detailed description about a configuration of the multi-standby terminal 300 is described subsequently with reference to FIG. 2.

The multi-standby terminal 300 includes a call waiting sound setting menu for setting the call waiting sound. Thereby, the user can set one of contents stored in the multi-standby terminal 300 to call waiting sound using the call waiting sound setting menu. In the present exemplary embodiment, the multi-standby terminal 300 can set the call waiting sound to be distinguishable based on, for example, a phone number basis or on a group basis. Therefore, in the present exemplary embodiment, in order to provide call waiting sound, it is unnecessary to subscribe to an additional service and contents stored in the user' terminal can be set as the call waiting sound, thereby improving user convenience.

FIG. 2 is a block diagram illustrating a configuration of a multi-standby terminal 300 according to another exemplary embodiment of the present invention.

Referring now to FIGS. 1 and 2, the multi-standby terminal 300 includes a first controller 110, first storage unit 120, display unit 130, first slot 140, first RF unit 150, intermediate communication processor 160, input unit 170, audio processor 180, second controller 210, second storage unit 220, second slot 240, and a second RF unit 250.

The first slot 140 comprises a coupling component for receiving a first user identity card 41 and performs a function as an interface unit for coupling the first user identity card 41 and the first controller 110. The first user identity card 41 (preferably a SIM card but not limited thereto) stores user certification information for using a first wireless communication network. For example, the first user identity card 41 may comprise a universal subscriber identity module (USIM) and a user identity module (UIM), just to name a few possibilities.

The second slot 240 comprises a coupling component for receiving a second user identity card 42 (preferably a SIM card but not limited thereto) and performs a function as an interface unit for connecting the second user identity card 42 and the second controller 210. The second user identity card 42 stores user certification information for using a second wireless communication network. Similar to the first user identity card 41, the second user identity card 42 may comprise a SIM, an USIM and an UIM, just to name a few possibilities. Nor is there any requirement that the first identity card and the second identity card match, although for ease of construction, similar first and second slots that receive a same type of card would be preferred.

The first RF unit 150 transmits and receives a wireless signal to and from a first wireless communication network 1000 (FIG. 1) for providing a communication service using a first wireless communication protocol. For this function, the first RF unit 150 modulates a signal output from the first controller 110, up-converts a frequency of the signal, and transmits the signal through a first antenna 10, or down-converts a frequency of a wireless signal received through the first antenna 10, demodulates the signal, and outputs the signal to the first controller 110. Particularly, in the present exemplary embodiment, when the first terminal 100 is set to a call waiting state, the first RF unit 150 transmits call waiting sound to the first terminal 100 by the control of the first controller 110.

The second RF unit 250 transmits and receives a wireless signal to and from a second wireless communication network 2000 (FIG. 1) for providing a communication service using a second wireless communication protocol. The second RF unit 250 modulates a signal output from the second controller 210, up-converts a frequency of the signal, and transmits the signal through a second antenna 20, or down-converts a frequency of a wireless signal received through the second antenna 20, demodulates the signal, and outputs the signal to the second controller 210. Particularly, in the present exemplary embodiment, when the second terminal 200 is set to a call waiting state, the second RF unit 250 transmits call waiting sound to the second terminal 200 by the control of the second controller 210.

In FIG. 2, the first RF unit 150 and the second RF unit 250 each have a separate antenna 10, 20, respectively, but the present invention is not limited thereto. The first RF unit 150 and the second RF unit 250 may use one antenna. In this case, it is preferable that the multi-standby terminal 300 includes a means (for example, a diplexer) for separating a frequency band of the first RF unit 150 and the second RF unit 250.

The input unit 170 includes a plurality of input keys and function keys for receiving numeral or character information and setting various functions. The function keys preferably include a direction key, side key, and hotkey that are set to perform a specific function. Particularly, in the present exemplary embodiment, the input unit 170 includes a function key for generating another party change signal for changing to another party. The function key for changing another party may comprise a communication key. When a function key (hereinafter, a communication key) signal for changing another party is input, the multi-standby terminal 300 can change a state of a specific terminal while performing communication to a call waiting state and perform communication with another terminal in a call waiting state.

The audio processor 180 converts an audio signal to an audible sound through a speaker SPK (not shown) and outputs the audible sound, or outputs a sound signal input through a microphone MIC (not shown) to the first controller 110. Particularly, in the present exemplary embodiment, when a communication request is received from the second terminal 200 while performing communication with the first terminal 100, the audio processor 180 outputs a signal, i.e. call connection sound notifying of the request by the control of the first controller 110.

The first storage unit 120 stores general operations of the multi-standby terminal 300, a program necessary for performing communication with the first wireless communication network, and data generated while performing the program. That is, the first storage unit 120 stores an operating system for booting the multi-standby terminal 300, an application program necessary for a function operation of the multi-standby terminal 300, and data generated according to use of the multi-standby terminal 300. Particularly, in the present exemplary embodiment, the first storage unit 120 stores contents, such as an audio file, and a moving picture file for transmitting to a terminal that is set to a call waiting state. Further, the first storage unit 120 includes a call waiting sound setting menu for setting call waiting sound.

When contents stored in the first storage unit 120 are set as call waiting sound, if the first terminal 100 is set to a call waiting state, the contents that are set as s call waiting sound are transmitted to the first terminal 100 through the first RF unit 150 by the control of the first controller 110.

In addition, when the second terminal 200 is set to a call waiting state, contents that are set as the call waiting sound are output to the second controller 210 through the intermediate communication processor 160 and are transmitted to the second terminal 200 through the second RF unit 250.

The second storage unit 220 stores a program necessary for performing communication with the second wireless communication network and data generated while performing the program. Particularly, in the present exemplary embodiment, the second storage unit 220 stores contents such as an audio file and a moving picture file for transmitting to a terminal that is set to a call waiting state. When contents stored in the second storage unit 220 are set to call waiting sound, if the second terminal 200 is set to a call waiting state, contents that are set as the call waiting sound are transmitted to the second terminal 200 through the second RF unit 250 by the control of the second controller 210. When the first terminal 100 is set to the call waiting state, contents that are set as the call waiting sound are output to the first controller 110 through the intermediate communication processor 160 and are transmitted to the first terminal 100 through the first RF unit 150.

In FIG. 2, the first storage unit 120 and the second storage unit 220 are described as separate elements, but the present invention is not limited thereto. The first storage unit 120 and the second storage unit 220 can be formed by dividing an area of a memory into two areas, for example.

The display unit 130 displays various menu screens of the multi-standby terminal 300, user data input by the user, function setting information, or various information provided to the user. When the display unit 130 is formed as a touch screen, the display unit 130 can be operated as an input unit in addition to functioning as a display. The display unit 130 can be formed with a liquid crystal display (LCD) and an organic light-emitting diode (OLED). Particularly, in the present exemplary embodiment, the display unit 130 displays a call waiting setting menu screen by the control of the first controller 110. In this case, the display unit 130 displays a list of contents stored in at least one of the first storage unit 120 and the second storage unit 220.

With continued reference to FIG. 2, the first controller 110 controls general operations of the multi-standby terminal 300 and a signal flow between units of the multi-standby terminal 300. That is, the first controller 110 performs a function of a main controller. Particularly, in the present exemplary embodiment, while performing communication with the first terminal 100 using the first RF unit 150, when the first controller 110 receives a communication request of the second terminal 200 through the second RF unit 250, the first controller 110 notifies the user of this. The first controller 110 outputs call connection sound through the audio processor 180. In this case, when the user accepts a communication connection with the second terminal 200, the first controller 110 controls to set the first terminal 100 to a call waiting state and to perform communication with the second terminal 200. Further, the first controller 110 controls to output preset call waiting sound through the first RF unit 150. The call waiting sound may comprise, for example, a music file or a moving picture file, just to name a few possibilities. In this case, when the call waiting sound is stored in the second storage unit 220, the first controller 110 receives the call waiting sound through the intermediate communication processor 160. Further, when the first controller 110 receives a communication connection termination signal from the first terminal 100 in a communication state or a call waiting state, the first controller 110 terminates a communication connection with the first terminal 100.

The second controller 210 is a sub-controller of the multi-standby terminal 300 and performs a communication function with the second terminal 200 using the second RF unit 250. When the second controller 210 receives a communication request signal from the second terminal 200, the second controller 210 notifies the first controller 110 of this. Particularly, in the present exemplary embodiment, when the second terminal 200 is set to a call waiting state and the call waiting sound is stored in the second storage unit 220, the second controller 210 transmits the call waiting sound to the second terminal 200 through the second RF unit 250. When the first terminal 100 is set to a call waiting state, the second controller 210 outputs contents set to the call waiting sound to the first controller 110 through the intermediate communication processor 160. Thereafter, the first controller 110 transmits the received contents to the first terminal 100 through the first RF unit 150.

When contents stored in the first storage unit 120 are set as the call waiting sound, if the second terminal 200 is set to the call waiting state, the second controller 210 receives contents set as the call waiting sound through the intermediate communication processor 160 and transmits the contents to the second terminal 200 through the second RF unit 250. Further, when the second controller 210 receives a communication termination signal from the second terminal 200 in a communication state or a call waiting state, the second controller 210 terminates communication with the second terminal 200.

The intermediate communication processor 160 is an intermediary for enabling the first controller 110 and the second controller 210 having different communication specifications to give and receive data. The intermediate communication processor 160 uses a dual ported RAM (DPRAM). Particularly, in the present exemplary embodiment, when contents stored in the first storage unit 120 are set as call waiting sound, if the second terminal 200 is in a call waiting state, the intermediate communication processor 160 outputs contents stored in the first storage unit 120 to the second controller 210 and transmits the contents to the second terminal 200 by the control of the first controller 110. Alternatively, when contents stored in the second storage unit 220 are set as the call waiting sound, if the first terminal 100 is in a call waiting state, the intermediate communication processor 160 outputs contents stored in the second storage unit 220 to the first controller 110 and transmits the contents to the first terminal 100 by the control of the second controller 210.

Although not shown, the multi-standby terminal 300 may further include modules having additional functionality, such as a camera module for photographing an image or a moving picture, a short range communication module for performing short range wireless communication, broadcasting reception module for receiving broadcasting, and a digital sound source reproduction module such as an MP3 module.

A method of providing call waiting sound of a multi-standby terminal according to another exemplary embodiment of the present invention is provided hereinafter.

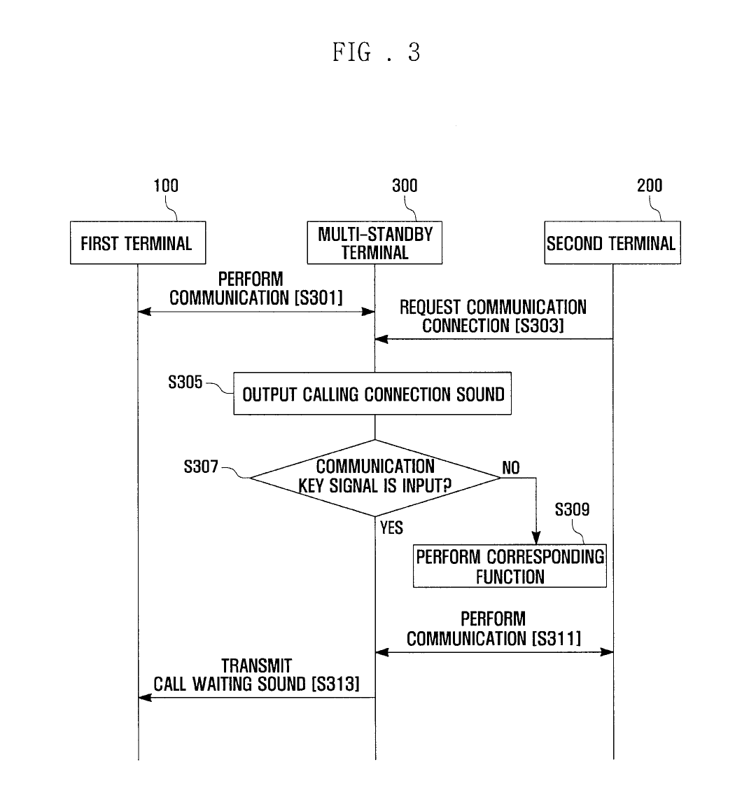

FIG. 3 is a flowchart illustrating a method of providing a call waiting sound of a multi-standby terminal according to another exemplary embodiment of the present invention.

Referring now to FIG. 3, at step (S301), the multi-standby terminal 300 and the first terminal 100 perform communication through the first RF unit 150. At step (303), the second terminal 200 requests a communication connection to the multi-standby terminal 300.

At step (S305), the multi-standby terminal 300, which has received a communication connection request from the second terminal 200 while still in communication with the first terminal 100, outputs a signal, i.e. a calling connection sound notifying this.

At step (S307), the multi-standby terminal 300 determines whether a function key (hereinafter, a communication key) signal for changing to another party is input.

If the communication key signal for changing to another party is not input, then at step (S309), the multi-standby terminal 300 performs a corresponding function. For example, the multi-standby terminal 300 determines whether a communication termination signal for terminating communication with the first terminal 100 is input. If a communication termination signal for terminating communication with the first terminal 100 is input, the multi-standby terminal 300 then terminates communication with the first terminal 100. If at step (S307) the communication key signal for changing to another party is input, at step (311) the multi-standby terminal 300 performs communication with the second terminal 200. At step (S313), the multi-standby terminal 300 sets the first terminal 100 to a call waiting state and transmits the preset call waiting sound to the first terminal 100. The call waiting sound may be contents such as a music file and a moving picture file stored in the multi-standby terminal 300. Further, the call waiting sound can be differently set on a phone number basis or on a group basis.

Although not shown in FIG. 3, when the communication key signal is input, the multi-standby terminal 300 changes a terminal for performing communication.

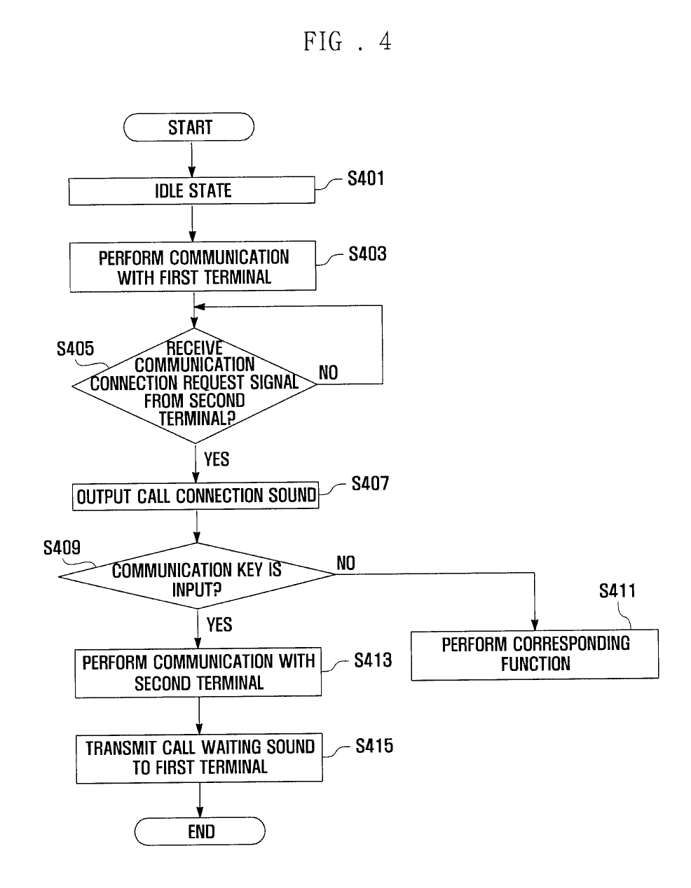

FIG. 4 is a flowchart illustrating a method of providing call waiting sound of a multi-standby terminal according to another exemplary embodiment of the present invention.

Referring now to FIG. 4, at step (S401), the multi-standby terminal 300 is in an idle state. At step (S403), the first controller 110 of the multi-standby terminal 300 receives a communication request from the first terminal 100, or transmits a communication request to the first terminal 100 to perform communication with the first terminal 100. In this case, the first controller 110 performs communication with the first terminal 100 using the first RF unit 150.

At step (S405), the second controller 210 of the multi-standby terminal 300 receives a communication connection request signal from the second terminal 200 through the second RF unit 250. The second controller 210, having received the communication connection request signal notifies the first controller 110 of this request.

At step (S407), the first controller 110 outputs a signal, i.e. a call connection sound, notifying that a communication request is received from the second terminal 200 through the audio processor 180. At step (S409), the first controller 110 determines whether a function key (hereinafter, a communication key) signal for changing another party is input.

If a communication key signal for changing to another party is not input, at step (S411) the first controller 110 performs a corresponding function. For example, the first controller 110 sustains a communication function with the first terminal 100, and if a communication termination signal is input, the first controller 110 terminates communication with the first terminal 100. If, at step (S409), a communication key signal for changing to another party is input, at step (S413) the first controller 110 controls to perform communication with the second terminal 200. At step (S415), the first controller 110 controls setting of the first terminal 100 to a call waiting state and transmitting of a preset call waiting sound to the first terminal 100. In this case, when contents that are set as call waiting sound are stored in the second storage unit 220, the first controller 110 receives contents that are set as call waiting sound through the intermediate communication processor 160 and transmits the contents to the first terminal 100. Here, the call waiting sound may be contents (for example, an MP3 file and a moving picture file) stored in one of the first storage unit 120 or the second storage unit 220. The call waiting sound may be differently set on a phone number basis or on a group basis.

Although not shown in FIG. 4, if the communication key signal for changing to another party is input after step 415, the first controller 110 controls setting of the second terminal 200 to a call waiting state and performing communication with the first terminal 100. That is, when a communication key signal for changing another party is input, the first controller 110 controls to alternately perform communication with the first terminal 100 or the second terminal 200. Further, when a communication termination signal is received from at least one of the first terminal and the second terminal 200, the multi-standby terminal 300 terminates communication with a terminal, having transmitted the communication termination signal.

As described herein above, in a multi-standby terminal and a method of providing call waiting sound of the multi-standby terminal according to the presently claimed invention, a call waiting sound can be provided to another party's mobile terminal that is set to a call waiting state without subscribing to an additional service for providing a call waiting service or the call waiting sound. Further, a user can set contents stored in the user's terminal to the call waiting sound, thereby improving user convenience.

Although exemplary embodiments of the present invention have been described in detail hereinabove, a person of ordinary skill in the art should understand that many variations and modifications of the basic inventive concepts herein described, which may appear to those skilled in the art, will still fall within the spirit and scope of the exemplary embodiments of the present invention as defined in the appended claims. For example, the first RF unit and second RF unit could be a single RF unit with two communication channels and a diplexer antenna.

The above-described methods according to the present invention can be realized in hardware or as software or computer code that can be stored in a recording medium such as a CD ROM, a RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

What is claimed is:

1. A method of providing call waiting sound for a multi-standby terminal that performs call waiting with a plurality of wireless communication networks, comprising:
performing communication with a first terminal through a first radio frequency (RF) unit;
receiving a communication connection request from a second terminal through a second RF unit;
determining whether a function key signal for changing to another party is input;
setting, if a function key signal for changing to another party is input, the first terminal to a call waiting state and performing communication with the second terminal; and
transmitting a preset call waiting sound to the first terminal that is associated with the call waiting state through the first RF unit.

2. The method of claim 1, further comprising:
setting the preset call waiting sound as contents stored in one of a first storage unit or a second storage unit.

3. The method of claim 2, wherein transmitting the preset call waiting sound to the first terminal that is set to a call waiting state through the first RF unit comprises transmitting the contents stored in the first storage unit to the first terminal through the first RF unit, when the call waiting sound is set as contents stored in the first storage unit.

4. The method of claim 2, wherein transmitting the preset call waiting sound to the first terminal that is set to a call waiting state through the first RF unit comprises receiving the contents stored in the second storage unit through an intermediate communication processor and transmitting the contents to the first terminal through the first RF unit, when the call waiting sound is set as contents stored in the second storage unit.

5. The method of claim 2, wherein setting the call waiting sound comprises setting a distinguishable call waiting sound corresponding to a phone number basis or on a group basis.

6. The method according to claim 1, wherein the first terminal and the second terminal communicate with the multi-standby terminal via different networks.

7. The method according to claim 1, wherein the first terminal and the second terminal communicate with the multi-standby terminal via different channels of a same network.

8. The method according to claim 1, wherein the first terminal and the second terminal communicate with the multi-standby terminal via different wireless protocols.

9. The method according to claim 1, wherein the first terminal and the second terminal communicate with the multi-standby terminal via a same wireless protocol.

10. A multi-standby terminal comprising:
a first RF unit for forming a communication channel with a first terminal;
a second RF unit for receiving a communication request from a second terminal;
an audio processor for outputting a call connecting sound notifying that a communication request from the second terminal is received;
an input unit including a function key for generating an another party change signal for requesting changing to another party;
a first controller for controlling, when an another party change signal is input, setting of the first terminal to a call waiting state and transmitting a preset call waiting sound to the first terminal through the first RF unit; and
a second controller for controlling performing a communication with the second terminal through the second RF unit.

11. The multi-standby terminal of claim 10, wherein the first controller controls transmitting the call waiting sound to the first terminal through the first RF unit, when call waiting sound is stored in a first storage unit.

12. The multi-standby terminal of claim 10, wherein the first controller controls receiving the call waiting sound through an intermediate communication processor and transmitting the call waiting sound to the first terminal through the first RF unit, when call waiting sound is stored in the second storage unit.

13. The multi-standby terminal of claim 10, wherein the first storage unit stores a call waiting sound setting menu for setting the call waiting sound.

14. The multi-standby terminal of claim 10, wherein the call waiting sound is set in accordance with a phone number basis or on a group basis.

15. The multi-standby terminal of claim 10, wherein the first terminal and the second terminal communicate with the multi-standby terminal via different networks.

16. The multi-standby terminal of claim 10, wherein the first terminal and the second terminal communicate with the multi-standby terminal via different channels of a same network.

17. The multi-standby terminal of claim 10, wherein the first terminal and the second terminal communicate with the multi-standby terminal via different wireless protocols.

18. The multi-standby terminal of claim 10, wherein the first terminal and the second terminal communicate with the multi-standby terminal via a same wireless protocol.
